(19) United States
(12) Patent Application Publication
(10) Pub. No.: US 2009/0157716 A1
(43) Pub. Date: Jun. 18, 2009

(54) APPARATUS AND METHOD FOR ACQUIRING DATA FROM MEMORY OF TERMINAL

(76) Inventors: Keonwoo KIM, Daejeon-city (KR); Dowon HONG, Daejeon-city (KR); Kyoil CHUNG, Daejeon-city (KR)

Correspondence Address: LADAS & PARRY LLP, 224 SOUTH MICHIGAN AVENUE, SUITE 1600, CHICAGO, IL, 60604, US

(21) Appl. No.: 12/140,350

(22) Filed: Jun. 17, 2008

(30) Foreign Application Priority Data
Dec. 17, 2007 (KR) 10-2007-0132676

(51) Int. Cl. G06F 17/30

(52) U.S. Cl. 707/101; 707/E17.009

(57) ABSTRACT

The present invention relates to an apparatus and method for acquiring data stored in a memory of a terminal. Binary data is converted to a new case file and the case file is stored. When meaningful data is extracted, a copy of the case file is generated and the integrity of the copied case file is checked. Then, meaningful data is extracted. A report is generated to correspond to the analyzed meaningful data and is output to a printer and a monitor. Therefore, according to the present invention, all of the data stored in the memory of the terminal are acquired and are converted into the case file in a new format, thereby generating legitimate evidence material for a legal investigation in respect to a legal aspect to be used by investigators.

### BACKGROUND OF THE INVENTION

1. Field of the Invention

The present invention relates to an apparatus and method for acquiring data from a memory of a terminal, and more particularly, to an apparatus and method for acquiring available data stored in a memory of a terminal.

This work was supported by the IT R&D program of MIC/IITA. [2007-S-019-01, Development of Digital Forensic System for Information Transparency]

2. Description of the Related Art

In existing methods of acquiring data from memories of terminals, a computer and a terminal are connected to each other by an USB cable and the computer acquires data from the terminal using a logical protocol. The computer copies flash memory data and file systems stored in the terminal. At the present time, commonly used software for copying exists. However, this cannot be commonly applied to all types of terminals because logical protocols may be different from each other in accordance with terminal service providers, terminal manufacturers, and terminal models.

Methods of acquiring data from terminals using a low-level approaching method, for example, using a JTAG interface extract available data directly from binary data acquired from terminals. These types of methods for acquiring data from terminals cannot acquire acquisition and investigation related information such as investigators and evidence acquisition date and do not include an integrity checking process on copied binary data. Therefore, the above method cannot be used to generate legitimate evidence with legal binding force in respect to a legal aspect.

### SUMMARY OF THE INVENTION

Accordingly, the present invention has been made to solve the above-described problems, and it is an object of the present invention to provide an apparatus and method for acquiring all data from a memory of a terminal, which acquire binary data from the memory of the terminal, convert the acquired binary data into an original case file having a new format to ensure the validity of legal evidence and investigation which is used in respect to a forensic investigation, stores the original case file, generates a copy of the original case file, checks the integrity of the copied case file, and extracts meaningful evidence data from the copied case file.

According to an aspect of the present invention, there is provided an apparatus for acquiring data from a memory of a terminal. The apparatus includes a format converter that converts binary data into a format with legal binding force to generate an original case file; an original case file copier that copies the original case file to generate a copied case file using the original case file generated by the format converter; an integrity check unit that checks the integrity of the copied case file; and an meaningful data acquisition unit that extracts meaningful data from the copied case file whose integrity is verified by the integrity check unit.

The meaningful data acquisition unit may request the integrity check unit to check the integrity of the copied case file, and when the meaningful data acquisition unit issues a request to check the integrity, the integrity check unit may check the integrity of the copied case file.

The format converter may include a binary data input unit that receives a number of binary files; a converter that combines the received binary files to generate combined binary data and adds a case file head to the combined binary data; and a hash calculation unit that calculates a hash value regarding the combined binary data and the case file head.

The case file head may include a data acquisition date, a data acquisition time, terminal information, and a case file length.

The integrity check unit may compare a hash value of the copied case file to a hash value of the original case file to check the integrity of the copied case file.

The meaningful data acquisition unit may include a calling unit that calls the integrity check unit and requests to check the integrity of the copied case file, a copied case file reading unit that reads the copied case file whose integrity is verified by the integrity check unit, when the integrity check unit checks the integrity of the copied case file, and an data analyzer that extracts meaningful data from the read copied case file and analyzes the meaningful data.

The meaningful data may include at least one of MINs (mobile identification numbers), SMSs (short message service), telephone directories, telephone records, photos, moving pictures, schedules, and memos.

The apparatus according to the aspect of the present invention may further include a report output unit that generates a report in types corresponding to the meaningful data analyzed by the data analyzer and outputs the report together with case file head information to a printer and a screen of a monitor.

The report output unit may include a data searching unit that searches gets the available data analyzed by the data analyzer; a report making unit that generates a report with a predetermined format corresponding to the meaningful data searched by the data searching unit; and an output unit that outputs the contents of the report made in the predetermined format to a screen of a monitor or a printer.

According to another aspect of the present invention, there is provided a method of acquiring data from a memory of a terminal. The method includes acquiring binary data stored in the memory of the terminal; converting the acquired binary data into a format with legal binding force to generate an original case file; copying the generated original case file to generate a copied case file; checking the integrity of the copied case file; and reading the copied case file whose integrity is verified and acquiring available data from the copied case file.

The checking of the integrity may include determining whether a request to check the integrity of the copied case file is issued, and when the request to check the integrity of the copied case file is issued, checking the integrity of the copied case file.

The method according to another aspect of the present invention may further include analyzing the meaningful data; and generating a report in types corresponding to the analyzed meaningful data and outputting the report together with case file head information to a printer and a screen of a monitor.

The converting of the acquired binary data may include getting a number of binary files; combining the acquired binary files to generate combined binary data and adding a case file head to the combined binary data; and calculating a hash value regarding the combined binary data and the case file head.

The case file head may include a data acquisition date, a data acquisition time, terminal information, and a case file length.

In the checking the integrity, a hash value of the copied case file may be compared with a hash value of the original case file to check the integrity of the copied case file.

The meaningful data may include at least one of MINs, SMSs, telephone directories, telephone records, photos, moving pictures, schedules, and memos.

According to the present invention, all of the data stored in the memory of the terminal are acquired and converted into the case file with a new format, thereby generating legitimate evidence material for a legal investigation in respect to a legal aspect to be used by investigators. Further, since the meaningful data are acquired from the copied case file, it is possible to preserve binary data and the original case file without damage. Furthermore, it is possible to make a report with various formats which correspond to the meaningful data acquisition and to output the report.

### BRIEF DESCRIPTION OF THE DRAWINGS

FIG. 1 is a drawing illustrating an apparatus for acquiring data from a memory of a terminal according to an embodiment of the present invention;

FIG. 2 is a drawing illustrating a format of a case file applied to the present invention;

FIG. 3 is a drawing specifically illustrating the structure of the apparatus shown in FIG. 1; and

FIG. 4 is a drawing illustrating a method of acquiring data from a memory of a terminal according to another embodiment of the present invention.

### DESCRIPTION OF THE PREFERRED EMBODIMENTS

Embodiments of the present invention will be described in detail with reference to accompanying drawings. Hereinafter, repeated descriptions and descriptions of well-known structures and functions which may make the main idea of the present invention unclear will be omitted. Embodiments of the present invention are provided to those skilled in the art for more perfect explanation. Shapes and sizes of components can be exaggerated in the drawings for clarity of illustration.

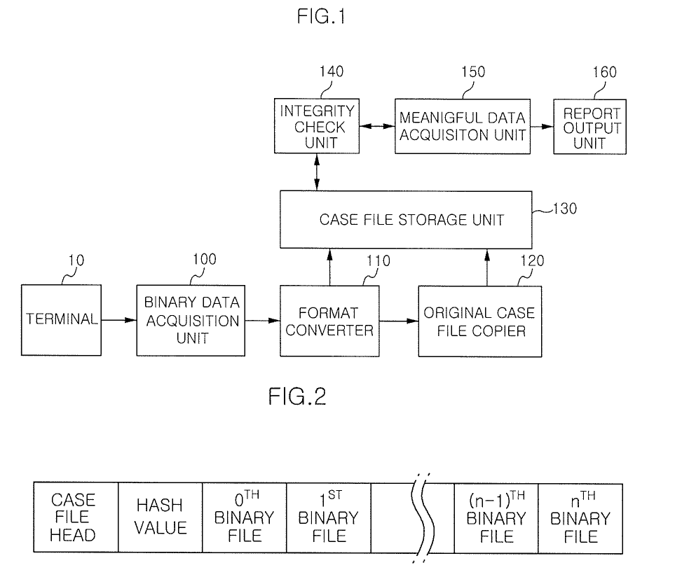

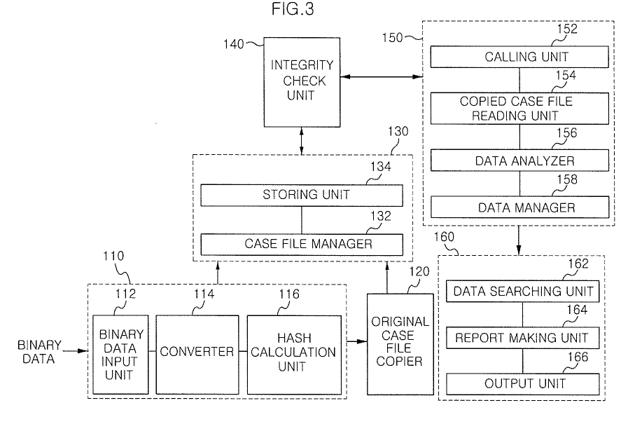

FIG. 1 is a drawing illustrating an apparatus for acquiring data from a memory of a terminal according to an embodiment of the present invention. FIG. 2 is a drawing illustrating a format of a case file applied to the present invention. FIG. 3 is a drawing specifically illustrating the structure of the apparatus shown in FIG. 1.

Referring to FIG. 1, an apparatus for acquiring data from a memory of a terminal according to an embodiment of the present invention includes a binary data acquisition unit 100, a format converter 110, an original case file copier 120, a case file storage unit 130, an integrity check unit 140, an meaningful data acquisition unit 150, and a report output unit 160.

The binary data acquisition unit 100 acquires binary data stored in a memory of a terminal 10. The binary data acquisition unit 100 may acquire binary data stored in the memory of the terminal 10 by using a JTAG interface. The terminal 10 and the binary data acquisition unit 100 may be connected to each other using JTAG pins found by disassembling the terminal 10. The binary data acquisition unit 100 includes a JTAG unit for the connection and a program for controlling the JPAG unit. When acquiring binary data from the memory of the terminal 10, the binary data acquisition unit 100 may variously set the size of acquirable binary data at a once. For example, when acquiring data from a 256 MB memory, the binary data acquisition unit may acquire data from 16 MB 16 times. The size of binary data to be acquired once may be set to correspond to the size of the memory of the terminal 10 or the JTAG unit. The binary data acquired by the binary data acquisition unit 100 are output in files marked with B0, B1, . . . , Bn-1, and Bn, respectively. Since a method of acquiring the binary data from the memory of the terminal 10 is well-known, a description thereof will be omitted.

The format converter 110 converts the binary files acquired by the binary data acquisition unit 100 into a format with legal binding force to generate a case file. To do this, the format converter 110 includes a binary data input unit 112, a converter 114, and a hash calculation unit 116.

The binary data input unit 112 selectively receives the binary files B0, B1, . . . , Bn-1, and Bn acquired by the binary data acquisition unit 100. The converter 114 combines (n+1) binary files to make one binary data and adds a case file head to the combined binary data for converting into a format with legal binding force. The case file head basically includes a data acquirer's name, a data acquisition date, a data acquisition time, terminal information, a case file length, etc. However, the case file head may include other information. The hash calculation unit 116 calculates a hash value regarding the combined binary data and the case file head and adds the hash value to the case file head. When the hash calculation unit 116 calculates the hash value, SHA1 and MD5 algorithms may be used. When a copy of the case file is used, the hash value is used to check the integrity of the copied case file.

The original case file copier 120 receives the case file generated by the format converter 110 (hereinafter, referred to as an “original case file”) and copies the original case file to generate a copied case file. The copied case file is used for data analysis, instead of the original case file.

The case file storage unit 130 stores the original case file generated by the format converter 110 and the copied case file generated by the original case file copier 120. To store those files, the case file storage unit 130 includes a case file manager 132 and a storing unit 134.

In order to manage a number of original and copied case files, the case file manager 132 manages the storage locations of the each case file and deletes original and copied case files stored in the storing unit 134 by a user's request.

If the meaningful data acquisition unit 150 issues a request to check the integrity of the copied case file, the integrity check unit 140 compares a hash value of the copied case file stored in the case file storage unit 130 with a hash value of the original case file to check the integrity of the copied case file. In some embodiments, when the meaningful data acquisition unit 150 issues a request to check the integrity of the copied case file, a check is performed on the integrity of the copied case file stored in the case file storage unit 130. However, the present invention is not limited thereto. Even if a request is not issued, it is possible to sequentially perform an integrity checking process on stored copied case files.

The integrity check unit 140 selectively checks the integrity of the copied case file in response to a request from the meaningful data acquisition unit 150. Meaningful data is extracted from only a copied case file which has the same hash value as the original case file (a copied case file (whose integrity is verified). That is, the meaningful data acquisition unit 150 extracts meaningful data from only a copied case file with the same hash value as the original case file but does not extracts meaningful data from the other copied case files with hash values different from the hash value of the original case file.

The meaningful data acquisition unit 150 extracts meaningful data from the copied case file whose integrity is verified by the integrity check unit 140 and analyzes and stores the meaningful data. The meaningful data acquisition unit 150 includes a calling unit 152, a copied case file reading unit 154, data analyzer 156, and an meaningful data manager 158.

The calling unit 152 calls the integrity check unit 140 and requests to check the integrity of each of the copied case files stored in the case file storage unit 130. If the integrity check unit 140 checks the integrity of each of the copied case files as described above, the copied case file reading unit 154 reads a copied case file whose integrity has been verified. The data analyzer 156 extracts meaningful data from the copied case file reading unit and analyzes the meaningful data. The meaningful data may be MINs, SMSs, telephone directories, telephone records, photos, moving pictures, schedules, memos, etc. The method acquiring and analyzing available data can vary on the basis of the operating system of a mobile terminal, a file system of an embedded flash memory, FTL (Flash Translation Layer), and a flash controller.

The meaningful data manager 158 may store, manage, and delete the meaningful data acquired and analyzed by the data analyzer 156.

The report output unit 160 generates a report in types and cases corresponding to the meaningful data extracted by the meaningful data acquisition unit 150 and outputs the reports together with case file head information to a printer and a screen of a monitor. To do this, the report output unit 160 includes a data searching unit 162, a report making unit 164, and an output unit 166.

The data searching unit 162 searches and gets data acquired by the meaningful data acquisition unit 150. The report making unit 164 generates a report with a predetermined format corresponding to the useful data searched by the data searching unit 162. The report may be used in a widely used word processor or in HTML, XML, etc. The output unit 166 outputs the contents of the report generated in the predetermined format to a screen of a monitor and a printer.

Hereinafter, a method of acquiring data from a memory of a terminal according to an embodiment of the present invention will be described.

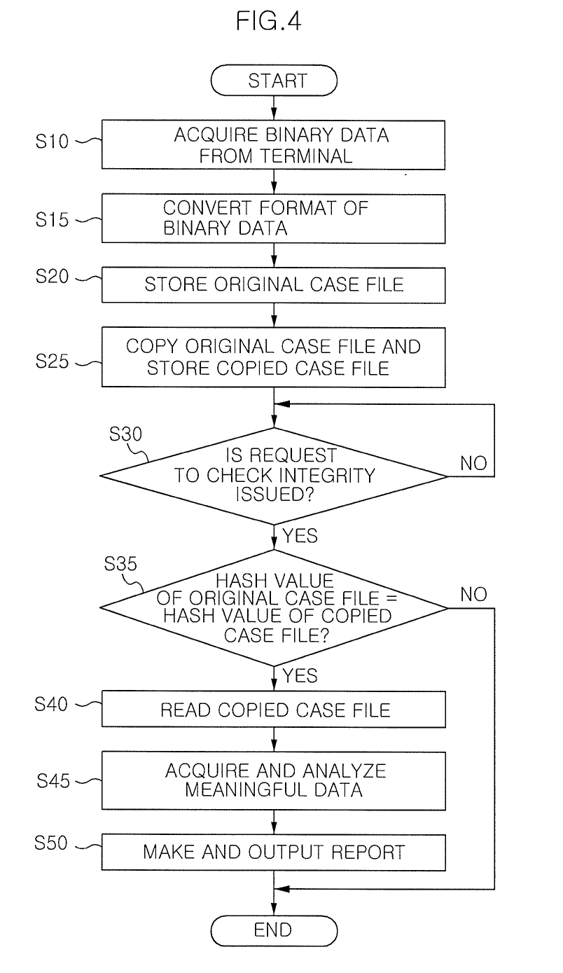

FIG. 4 is a drawing illustrating a method of acquiring data from a memory of a terminal according to an embodiment of the present invention.

First, the binary data acquisition unit 100 acquires binary data stored in the memory of the terminal 10 (S10). The binary data acquired by the binary data acquisition unit 100 are output in files marked with B0, B1, . . . , Bn-1, and Bn. Next, the format converter 110 converts the binary files acquired by the binary data acquisition unit 100 into a format with legal binding force to generate a case file (S15). Specifically, the format converter 110 selectively gets the binary files B0, B1, . . . , Bn-1, and Bn acquired by the binary data acquisition unit 100, combines the (n+1) binary files to generate combined binary data, and adds a case file head to the combined binary data for converting into a format with legal binding force. The case file head basically includes a data acquirer's name, a data acquisition date, a data acquisition time, terminal information, a case file length, etc. The format converter 110 calculates a hash value regarding the combined binary data and the case file head and adds the hash value to the case file head. The case file generated through the above-mentioned processes is stored in the case file storage unit 130 (S20). The original case file copier 120 copies the case file generated by the format converter 110 to generate a copied case file and stores the copied case file in the case file storage unit 130 (S25). Therefore, the case file storage unit 130 stores the original case file generated by the format converter 110 and the copied case file generated by the original case file copier 120. Next, the integrity check unit 140 determines whether the meaningful data acquisition unit 150 issues a request to check the integrity of the copied case file (S30). If the meaningful data acquisition unit 150 issues a request to check the integrity of the copied case file, the integrity check unit 140 compares a hash value of the copied case file stored in the case file storage unit 130 to the hash value of the original case file to check the integrity of the copied case file (S35). The meaningful data acquisition unit 150 reads the copied case file whose integrity is verified by the integrity check unit 140 (the copied case file having the same hash value as the original case file), extracts meaningful data from the copied case file, and analyzes and stores the available data (S40 and S45). The meaningful data may be MINs, SMSs, telephone directories, telephone records, photos, moving pictures, schedules, memos, etc. Finally, the report output unit 160 generates a report in types and cases corresponding to the meaningful data acquired by the meaningful data acquisition unit 150 and outputs the report together with the case file head information to a printer and a screen of a monitor (S50).

In the drawings and specification, there have been disclosed typical embodiments of the present invention and, although specific terms are employed, they are used in a generic and descriptive sense only and not for purposes of limitation. It will be apparent to those skilled in the art that modifications and variations can be made in the present invention without deviating from the spirit or scope of the invention. Thus, it is intended that the present invention cover any such modifications and variations of this invention provided they come within the scope of the appended claims and their equivalents.

What is claimed is:

1. An apparatus for acquiring data from a memory of a terminal, the apparatus comprising:
a format converter that converts binary data into a format with legal binding force to generate an original case file;
an original case file copier that gets the original case file generated by the format converter and copies the original case file to generate a copied case file;
an integrity check unit that checks the integrity of the copied case file; and
an meaningful data acquisition unit that extracts meaningful data from the copied case file whose integrity is verified by the integrity check unit.

2. The apparatus according to claim 1, wherein:
the meaningful data acquisition unit requests the integrity check unit to check the integrity of the copied case file, and
when the meaningful data acquisition unit issues a request to check the integrity, the integrity check unit checks the integrity of the copied case file.

3. The apparatus according to claim 1, wherein the format converter includes:
a binary data input unit that receives a number of binary files;
a converter that combines the received binary files to generate combined binary data and adds a case file head to the combined binary data; and
a hash calculation unit that calculates a hash value regarding the combined binary data and the case file head.

4. The apparatus according to claim 3, wherein the case file head includes a data acquisition date, a data acquisition time, terminal information, and a case file length.

5. The apparatus according to claim 1, wherein the integrity check unit compares a hash value of the copied case file with a hash value of the original case file to check the integrity of the copied case file.

6. The apparatus according to claim 1, wherein the meaningful data acquisition unit includes:
a calling unit that calls the integrity check unit and requests to check the integrity of the copied case file,
a copied file reading unit that reads the copied case file whose integrity is verified by the integrity check unit, when the integrity check unit checks the integrity of the copied case file, and
an data analyzer that extracts meaningful data from the copied case file and analyzes the meaningful data.

7. The apparatus according to claim 1, wherein the meaningful data includes at least one of MINs (mobile identification numbers), SMSs (short message service), telephone directories, telephone records, photos, moving pictures, schedules, and memos.

8. The apparatus according to claim 6, further comprising:
a report output unit that generates a report in types corresponding to the meaningful data analyzed by the data analyzer and outputs the report together with case file head information to a printer and a screen of a monitor.

9. The apparatus according to claim 8, wherein the report output unit includes:
a data searching unit that searches and gets the data analyzed by the data analyzer,
a report making unit that generates a report with a predetermined format corresponding to the meaningful data searched by the data searching unit, and
an output unit that outputs the contents of the report made in the predetermined format to a screen of a monitor or a printer.

10. A method of acquiring data from a memory of a terminal, the method comprising:
acquiring binary data stored in the memory of the terminal;
converting the acquired binary data into a format with legal binding force to generate an original case file;
copying the generated original case file to generate a copied case file;
checking the integrity of the copied case file; and
reading the copied case file whose integrity is verified and acquiring available data from the copied case file.

11. The method according to claim 10, wherein the checking of the integrity includes:
determining whether a request to check the integrity of the copied case file is issued, and
when the request to check the integrity of the copied case file is issued, checking the integrity of the copied case file.

12. The method according to claim 10, further comprising:
analyzing the meaningful data; and
generating a report in types corresponding to the analyzed meaningful data and outputting the report together with case file head information to a printer and a screen of a monitor.

13. The method according to claim 10, wherein the converting of the acquired binary data includes:
receiving a number of binary files;
combining the received binary files to generate combined binary data and adding a case file head to the combined binary data; and
calculating a hash value regarding the combined binary data and the case file head.

14. The method according to claim 13, wherein the case file head includes a data acquisition date, a data acquisition time, terminal information, and a case file length.

15. The method according to claim 10, wherein, in the checking the integrity, a hash value of the copied case file is compared with a hash value of the original case file to check the integrity of the copied case file.

16. The method according to claim 10, wherein the meaningful data includes at least one of MINs, SMSs, telephone directories, telephone records, photos, moving pictures, schedules, and memos.
